(19) United States
(12) Patent Application Publication
(10) Pub. No.: US 2018/0247328 A1
(43) Pub. Date: Aug. 30, 2018

(54) USE IT OR LOSE IT PROMOTIONS WITH E-TICKETING

(71) Applicant: PANASONIC INTELLECTUAL PROPERTY MANAGEMENT CO., LTD., Osaka (JP)

(72) Inventors: John CRONIN, Bonita Springs, FL (US); Jonathan T. GOGUEN, Brookline, NH (US); Joseph BODKIN, South Burlington, VT (US)

(21) Appl. No.: 15/906,767

(22) Filed: Feb. 27, 2018

Related U.S. Application Data
(60) Provisional application No. 62/464,674, filed on Feb. 28, 2017.

(51) Int. Cl. G06Q 30/02; G06F 17/30

(52) U.S. Cl. CPC G06Q 30/0224; G06F 17/30864

(57) ABSTRACT

Embodiments for tracking real-world activities are described herein. An exemplary system for tracking real-world activities may include a database and a server in communication with guest communication devices. Such a database may stores digital tickets for each of the guests of a venue, as well as information regarding a plurality of real-world activities that are each defined based on one or more conditions and associated with a predetermined reward. The server may include a communication interface that receives information captured by an active communication device of one of the guests and a processor that executes instructions to analyze the captured information to detect one or more conditions associated with one of the real-world activities and to update the digital ticket associated with the active communication device regarding the predetermined reward. A notification may then be sent to the active communication device regarding the reward.

### CROSS REFERENCE TO RELATED APPLICATIONS

This application claims priority to U.S. Provisional Application No. 62/464,674 filed on Feb. 28, 2017, the entire contents of which are hereby incorporated by reference.

### BACKGROUND

### Field of Disclosure

The present disclosure generally relates to digital ticketing. In particular, the present disclosure relates to detection and tracking of real-world activities in association with digital tickets.

### Description of the Related Art

Many theme parks, resorts, and similar types of service providers may wish to incentivize certain activities by their guests during their visit. Previously known incentive programs merely provide points based on verified activities and rewards for reaching certain benchmarks in terms of points. Some activities—such as online mailing list subscription, purchases, or reservations—may be easier to track and verify, because the user may be required to enter identification information (e.g., name, address, payment information).

A service provider may wish, however, to incentivize activities that are more difficult to track. Such activities are not necessarily confined to digital activities, however, but occur in the real world. For example, a service provider may wish to also reward such activities that involve an individual's physical presence or action in the real world, such as participation in certain games, attendance at parades, etc. Alternatively, the service provider may wish to alleviate certain inconveniences (e.g., waiting in line) by providing points or other incentives that may be redeemed for certain rewards.

Presently available loyalty programs or promotional campaigns may rely, however, either on cumbersome or time-consuming systems requiring individual in-person verification (e.g., obtaining stamps or proof). While each proof may individually not be time-consuming to obtain, obtaining multiple stamps over the course of a day when there may be numerous others doing the same may be extremely time-consuming cumulatively. A system that is cumbersome or time-consuming will lack participation, especially because individuals visiting a venue for a limited time period do not wish to waste their time.

Alternatively, self-verification systems are prone to being gamed, which discourages the service provider from offering prizes or awards that may either be expensive or otherwise undesirable to provide at large numbers. As a result, the guests may be less incentivized to participate if the prize for doing so is not special in some way.

There is, therefore, a need in the art for improved systems and methods for tracking real-world activities in association with digital tickets.

### SUMMARY OF THE DISCLOSURE

Embodiments of the present disclosure include systems and methods for tracking real-world activities. An exemplary system for tracking real-world activities may include a database and a server in communication with guest communication devices. Such a database may store digital tickets for each of the guests of a venue, as well as information regarding a plurality of real-world activities that are each defined based on one or more conditions and associated with a predetermined reward. The server may include a communication interface that receives information captured by an active communication device of one of the guests and a processor that executes instructions to analyze the captured information to detect one or more conditions associated with one of the real-world activities and to update the digital ticket associated with the active communication device regarding the predetermined reward. A notification may then be sent to the active communication device regarding the reward.

### BRIEF DESCRIPTION OF THE DRAWINGS

FIG. 1 illustrates an exemplary network environment in which a system for tracking real-world activities may be implemented.

FIG. 2 is a flowchart illustrating an exemplary method for tracking real-world activities.

FIG. 3A is a flowchart illustrating an exemplary method performed by an attraction check-in device.

FIG. 3B is a flowchart illustrating an exemplary method performed by an attraction check-out device.

FIG. 4 is a flowchart illustrating an exemplary method performed by a digital ticketing network server in communication with a guest communication device.

FIG. 5 is a flowchart illustrating an exemplary method performed by a digital ticketing network server that identifies rewards in response to the guest communication device.

FIG. 6 illustrates an exemplary entry from a user device database that may be used in a system for tracking real-world activities.

FIG. 7 illustrates an exemplary set of entries from a ticketing network guest database that may be used in a system for tracking real-world activities.

FIG. 8 illustrates an exemplary set of entries from ticketing network promotions database that may be used in a system for tracking real-world activities.

FIG. 9 illustrates an exemplary entry from a ticketing network rewards database that may be used in a system for tracking real-world activities.

FIG. 10 illustrates an exemplary screenshot of a graphic user interface (GUI) used for input at a user device that may be used in a system for tracking real-world activities.

FIG. 11 illustrates an exemplary screenshot of a graphic user interface (GUI) used for rewards transactions at a user device that may be used in a system for tracking real-world activities.

FIG. 12 illustrates an exemplary computing system (i.e. user device) that may be used to implement an embodiment of the present disclosure.

### DETAILED DESCRIPTION

Embodiments of the present disclosure include systems and methods for tracking real-world activities. An exemplary system for tracking real-world activities may include a database and a server in communication with guest communication devices. Such a database may store digital tickets for each of the guests of a venue, as well as information regarding a plurality of real-world activities that are each defined based on one or more conditions and associated with a predetermined reward. The server may include a communication interface that receives information captured by an active communication device of one of the guests and a processor that executes instructions to analyze the captured information to detect one or more conditions associated with one of the real-world activities and to update the digital ticket associated with the active communication device regarding the predetermined reward. A notification may then be sent to the active communication device regarding the reward.

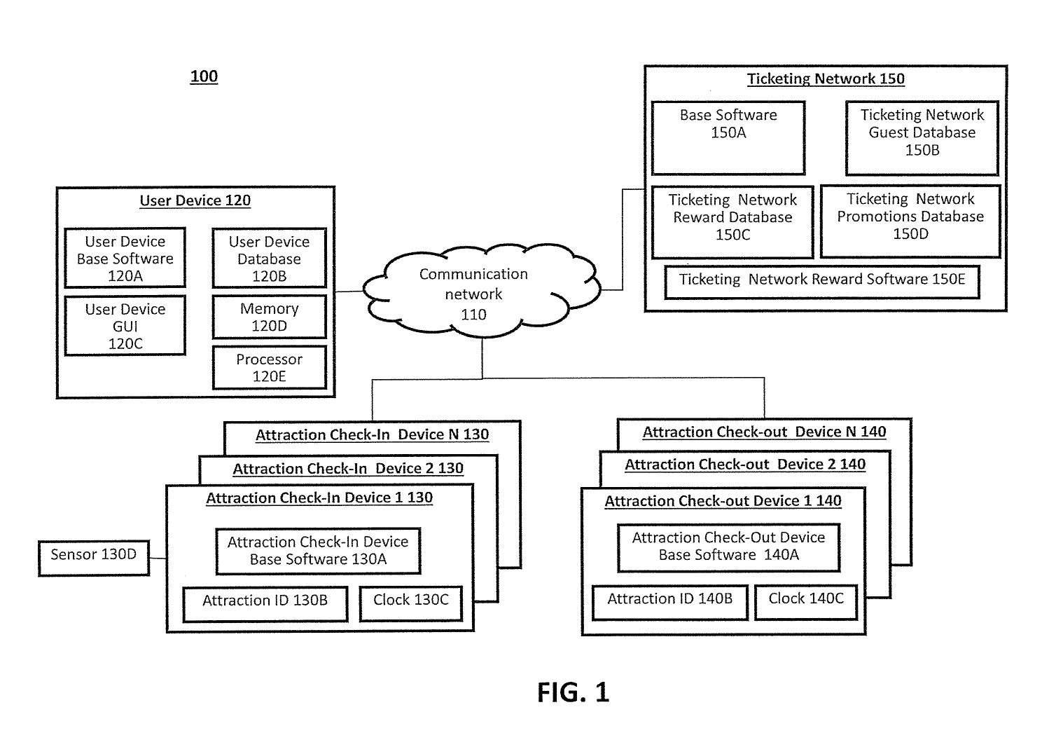

FIG. 1 illustrates an exemplary network environment 100 in which a system for tracking real-world activities may be implemented. Network environment 100 includes communication network 110 through which user device 120, attraction check-in devices 1-N 130, attraction check-out devices 1-N 140, and ticketing network server 150 may communicate with each other.

Communication network 110 may be a local, proprietary network (e.g., an intranet) and/or may be a part of a larger wide-area network. The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of network environment 100.

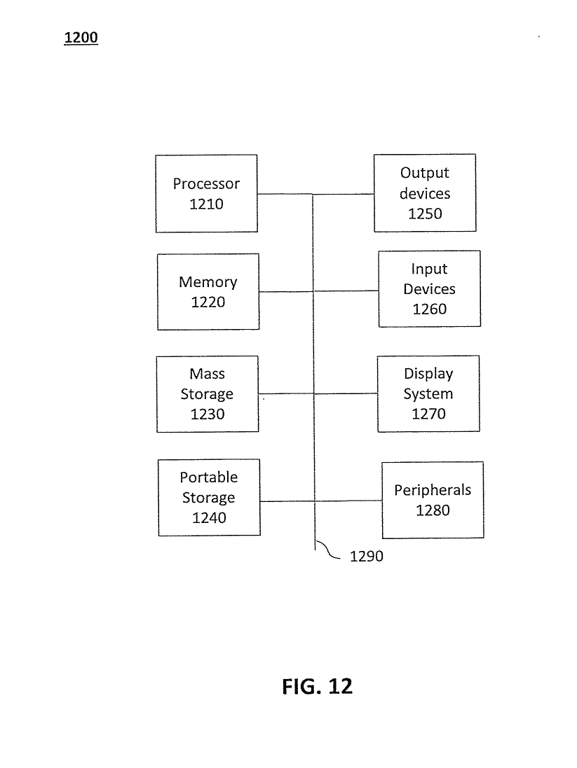

User device 120 may be any type of communication device known in the art, including general purpose computers, mobile phones, smartphones, personal digital assistants (PDAs), portable computing devices (e.g., laptop, netbook, tablets), desktop computing devices, handheld computing device, or any other type of computing device capable of communicating over communication network 110. User device 120 may be inclusive, for example, of a computing device such as described with respect to FIG. 12 herein.

User device 120 may include user device base software 120A, user device database 120B, user device GUI, 120C, memory, 120D, and processor 12E. User device base software 120A allows the user device 120 to perform the various functions described herein with respect to tracking of real-world activities, as well as various related communications. For example, user device base software 120A—which may be downloaded from an online application store or otherwise installed onto user device 120—may include instructions regarding how to track and evaluate a predetermined set of conditions within a vicinity of the user device 120.

Such conditions may be discernible based on a combination of sensors (e.g., GPS, accelerometers, microphone), clocks, and communications with various other devices (e.g., beacons at check-in devices, check-out devices, etc.) that may be indicative of the conditions. Such conditions may include any variety of contextual data concerning the guest visit, including line length, size of group, images of guest, expenditures at the venue, weather, and any other condition relating to the visit to the venue. The user base software 120A may further include instructions—embodied in non-transitory computer-readable storage media—on how to evaluate raw sensor data, as well as how to determine whether the data meets certain thresholds so as to meet the predetermined set of conditions (e.g., a certain line length). Such conditions may be defined by the service provider and may be based in part on details regarding the guest (e.g., registration, past visits, previous activity) that are associated with the digital ticket.

User device database 120B—which may be part of memory 120D—may store all information relating to the visit to the venue, including that information used in and resulting from tracking of real-world activities in association with a digital ticket. Such user device database 120B may include, for example, digital ticket information, registration details, historical information regarding the guest, previously tracked activities, previous rewards, etc.

User device GUI 120C may include any graphic user interface that requests and receives user input regarding preferences, registration, and other user-related information that may be used in tracking real-world activities in association with a digital ticket. Some of the information stored in user device database 120B may have come directly from user input by the guest via user device GUI 120C. Such information may include information entered directly by the guest regarding the attraction, including notes and photos. The user device GUI 120C may further be used to search for or browse through various promotions of interest.

User devices 120 may also be configured to access data from other storage media, such as memory cards or disk drives as may be appropriate in the case of downloaded services. User device 120 may include standard hardware computing components such as network and media interfaces, non-transitory computer-readable storage (memory), and processors 120E for executing instructions that may be stored in memory 120D.

The user device base software 120A may continuously poll for an attraction check-in device 130. Once a connection is made to an attraction check-in device 130, the user device 120 receives an attraction ID 130B, as well as check-in time as provided by clock 130C and other camera and context data as provided by sensor 130D. Such data may be stored in the user device database 120B. The user device 120 may then continuously poll for an attraction check-out device 140; and once the connection is made, the user device 120 receives the attraction ID 140B and check-out time as provided by clock 140C. Such data may likewise be stored in the user device database 120B. The user device 120 may then connect to the ticketing network server 150 (via communication network 110)—either periodically or in response to certain benchmarks or triggers—to communicate information stored in user device database 120B to the ticketing network server 150.

Attraction check-in devices 1-N 130 may be any communication device such as user device 120 or may be specialized transmitters distributed at different locations throughout a venue. Regardless, attraction check-in devices may send beacons that allow for the location of the user device 120 to be tracked, as well as trigger location-based actions (e.g., such as check-ins, notifications, etc.).

Attraction check-in devices 130 may include attraction check-in-device base software 130A, attraction identifier 130B, clock 130C, and sensor 130D. Attraction check-in-device base software 130A may include instructions embodied in non-transitory computer-readable storage media and executable by a processor of the respective attraction check-in device 130 to communicate information regarding certain conditions to the user device 120. As noted above, the conditions involved in tracking user activity may be defined by the service provider. The attraction check-in device 120 may therefore execute attraction check-in base software 130B to scan the local vicinity and identify the presence of any of the conditions of interest. Upon detection of one of the conditions of interest, the attraction check-in device 130 may communicate the same the user device 120. In some embodiments, raw data (e.g., number of guests in line) may be sent; in other embodiments, a communication is sent to user device 120 only when the data is determined to meet a threshold (e.g., a pre-specified number of guests).

The communication sent by the attraction check-in device 130 may include the specific identifier 130B of the attraction check-in device 130. Such identifier may be known to be associated with a specific location within a venue (e.g., the location of a particular attraction or service). The attraction check-in device 130 may further be pre-programmed with notes regarding contextual information regarding the attraction.

Clock 130C and sensor 130D may operate independent or cooperatively to provide information regarding conditions at the location of the attraction check-in device 130. For example, both clock 130C and sensor 130E may allow for determination of how long a particular guest has been waiting in line. Such time information may also be provided to user device 120 for incorporation into a calendar or otherwise assist with scheduling. Sensor 130D may be inclusive any of type of camera, microphone, environmental sensor, and related software for detecting and analyzing faces, voices, movement, etc., that may be indicative of an activity of interest.

Attraction check-out device 1-N 140 may correspond to attraction check-in device 1-N 130. For example, a particular attraction may include both an attraction check-in device 130 and a corresponding attraction check-out device 140. Such devices may be integrated or may be separate devices. For example, attraction check-in device 130 may be located at a waiting area of an attraction, while attraction check-out device 140 may be located at the exit of the attraction. Whereas attraction check-in device 130 may be used to identify when a guest arrived at the location, attraction check-out device 140 may be used to identify when the guest is leaving the location. Like attraction check-in device 130, attraction check-out device 140 includes base software 140A, attraction ID 140B, and clock 140C.

Ticketing network server 150 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

Ticketing network server 150 may include base software 150A, a guest database 150B, a reward database 150C, a promotion database 150D, and reward software 150E. Ticketing network server 150 may receive information sent over communication network 110 from user device 120, as well as attraction check-in devices 130, and attraction check-out devices 140. Such information—which may be associated with the digital ticket information of the guest—may collectively be used to identify when a particular guest has qualified for certain rewards under certain promotions (e.g., a guest visiting a specified set of attractions and participated in a specified set of activities may win points redeemable toward a prize). The promotions may be specific to the service provider or associated with third party advertisers.

Ticketing network base software 150A includes instructions embodied in non-transitory computer-readable storage media. Such instructions may include parameters regarding various promotional programs. Each promotional program—which may be specific to a particular service provider or one of their venues—may specify a set of conditions to be met before a reward is provided. Multiple rewards may be available, each associated with a different set of conditions. Rewards may be offered based on any combination of number of attractions visited, variety of attractions visited, time spent waiting in line, types of purchases made within the venue, and other factors reported to the ticketing network server 150.

As one or more conditions are reported from the user device 120, ticketing network base software 150A may parse the information, determine guest progress towards certain rewards available from certain promotions (in conjunction with reward software 150E), update the relevant databases (e.g., guest database 150B, reward database 150C, and promotions database 150D), and send notifications to the guest communication device (e.g., user device 120).

For example, the ticketing network server 150 may connect to the user device 120 and receive information presently maintained at the user device database 120B. The information from user device database 120B may then be stored in the ticketing network guest database 150B. The ticketing network reward software 150 may then be executed to identify a first applicable promotion program in the ticketing network promotion database 150D and to filter data from the ticketing network guest database 150B based on guest identity, promotion time period, and other promotion parameters. The ticket network guest database 150B is searched based on the promotion description and the set of conditions needed in order to achieve a reward under a promotion (e.g., visit the same attraction five times between 10:00 am and 2:00 pm in order to win a set of points redeemable towards a variety of discounts or prizes). If the user has not achieved the reward under a first available promotions, additional applicable promotions the ticketing network promotion database 150D may be evaluated with respect to filtered information from the ticketing network guest database 150B to determine qualification for rewards. If the user did achieve a reward, the reward and the promotion code from the ticketing network promotion database 150D are extracted and stored in the ticketing network rewards database 150C. Information from the ticketing network rewards database 150C is then sent to the ticketing network base software 150A.

If the ticketing network base software 150A does not receive any information from the ticketing network reward database 150C, the ticketing network reward software 150E may continue to evaluate incoming information sent from the user device 120. If the ticketing network base software 150A receives the ticketing network reward database 150C information, a notification is sent to the user device 120. If the user device 120 receives the notification, the reward may be displayed on the user device GUI 120C. But if the user device 120 does not receive any reward notifications, then the user device base software 120A may continue to poll for nearby attraction check-in 130 or check-out devices 140.

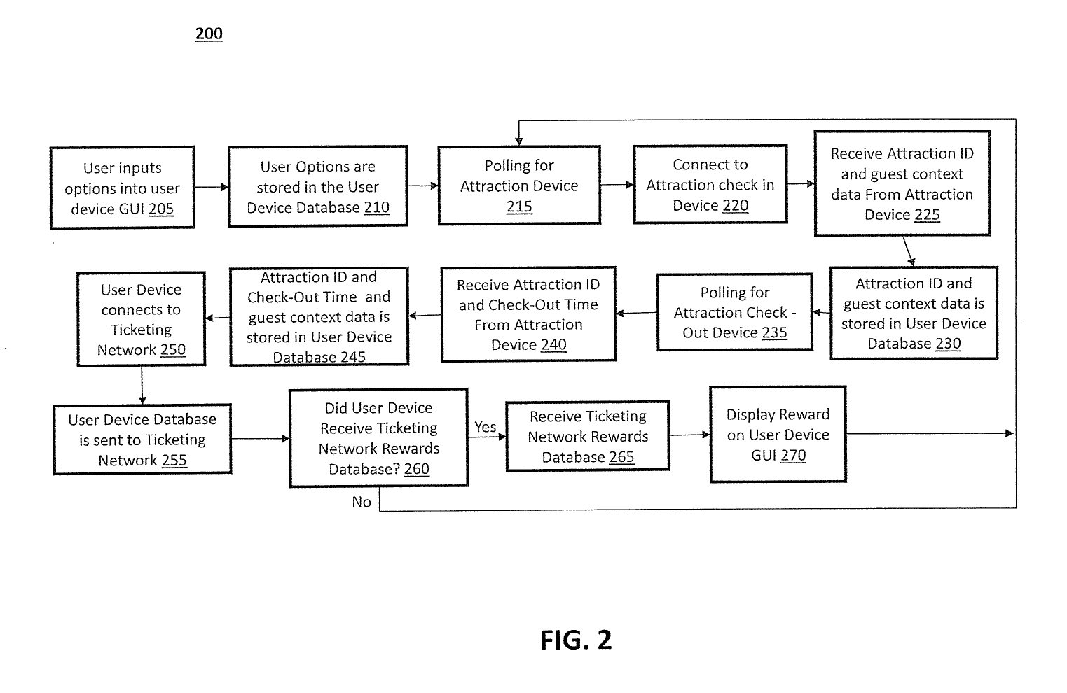

FIG. 2 is a flowchart illustrating an exemplary method 200 for tracking real-world activities via digital ticketing. Such a method 200 may be used to track the user's movement throughout a venue (e.g., amusement park) by allowing for automated check-ins and check-outs at each defined attraction location, each of which may further be associated with reports regarding various conditions at the attraction location as detected by various sensors. As such, user devices 120 may check in at each location, store and report the data to the ticketing network server 150, and display any resulting rewards on its GUI 120C.

In step 205, the user device GUI receives user input regarding a variety of options and preferences in relation to the visit. Such information may be part of an initial digital ticket registration, imported—with user approval—from various databases in the user device 120, or be input in response to prompts that appear when an application on the user device 120 is executed. Such information may be stored in the user device database 120D in step 210.

In step 215, the user device 120 may further continuously poll for an attraction check-in device 130. Once a connection is made to an attraction check-in device 130 in step 220, the user device may then receive an attraction ID 130B and guest context data, which is stored in the user device database 120B in step 230. The user device 120 may then continuously poll for an attraction check-out device 140 in step 235. Once the connection is made, the user device receives the attraction ID 140B and guest context data from the attraction check-out device 140 in step 240. The received data may be stored in the user device database 120B in step 245.

In step 250, the user device may connect to the ticketing network server 150, and in step 255, the information from the user device database 120B may be sent to the ticketing network server 150. Ticketing network rewards database 150C may indicate whether the guest associated with the user device 120 has qualified for a reward in step 260. If the user device 120 receives a notification in step 265, the reward is displayed on the user device GUI in step 270. If the user device 120 does not receive a reward notification, the method may revert to step 215 in which user device 120 may continue to poll for another attraction check-in device 140.

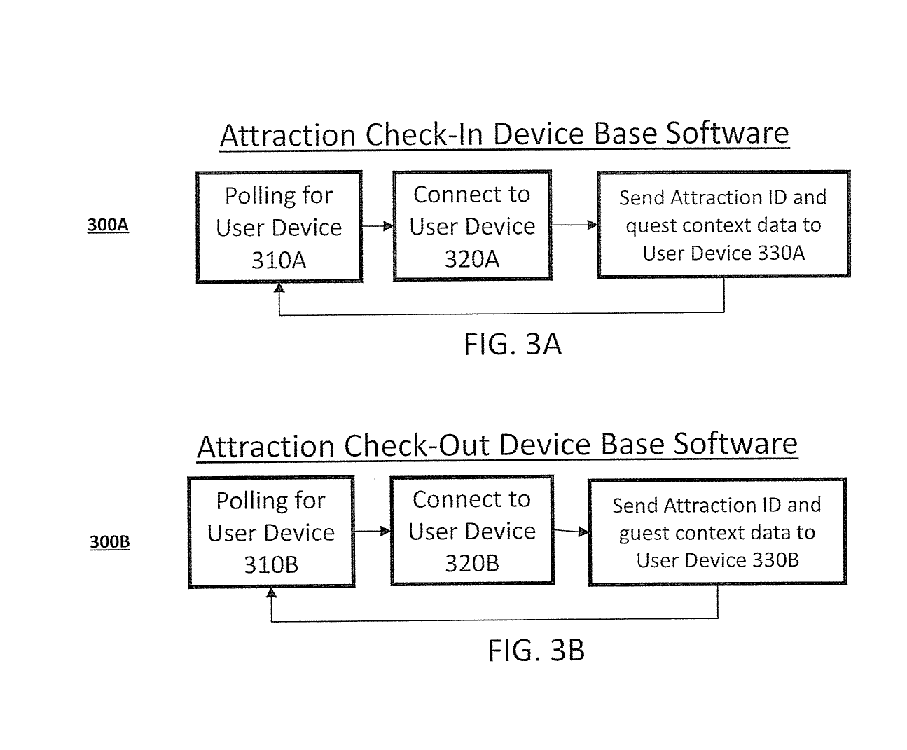

FIG. 3A is a flowchart illustrating an exemplary method 300A performed by an attraction check-in device 130. In step 310A, the attraction check-in device 130 polls for user devices 120 within range to receive the polling beacon. Upon detection of a nearby user device 120, the attraction check-in device 140 connects to the detected user device 120 in step 320A. In step 330A, the attraction check-in device 140 then sends its attraction ID 140B and context data (e.g., as detected by sensor 130D) to the user device. Returning back to step 310A, the attraction check-in device 140 then reverts back to polling for another nearby user device 120. As noted above, the attraction check-in device 140 may be located at the beginning of a line for an attraction in order to “check-in” a user device 120. The time as provided by the clock 130C may be used to determine the waiting time of user, as well as other contexts of the environment at the location that may be experienced by the guest. Where the sensor 130D is a sensor, for example, the guest context data may include images of the guest in line to determine facial expressions or body language indicative of bad moods. Similarly, recordings may be analyzed to detect any voiced complaints or comments.

FIG. 3B is a flowchart illustrating an exemplary method 300B performed by an attraction check-out device 140. In step 310B, the attraction check-out device 140 may poll for a nearby user device 120, and in step 320B, the attraction check-out device 140 may connect to the user device 120. In step 330B, the attraction check-out device 140 may then send the attraction ID 140B, as well as time from clock 140C and guest context data to the user device 120. Returning to step 310B, the attraction check-out device 140 may then revert back to polling for another user device 120. The attraction check-out device 140 may be located at an exit of an attraction in order to “check-out” a user device 120. The time provided from clock 140C may be used to determine the waiting time, as well as other contexts around the guest. Such contexts may be a condition of an improved reward.

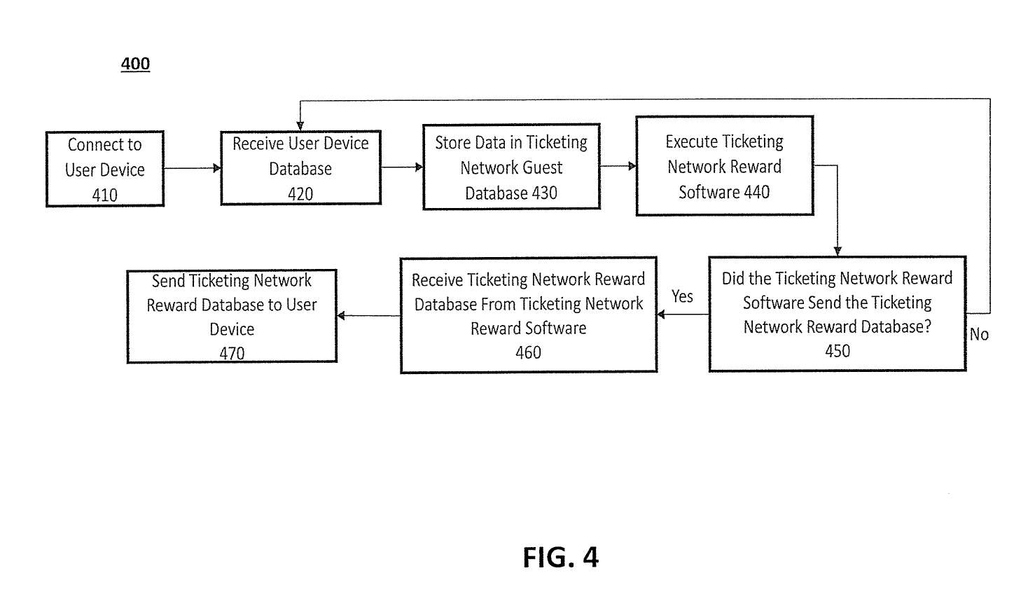

FIG. 4 is a flowchart illustrating an exemplary method 400 performed by a digital ticketing network server 150 in communication with a guest communication device 120 concerning a reward. In step 410, ticketing network server 150 connects to the user device 120 and in step 420, receives reports of information from the user device database 120B. In step 430, the user device database 120B information is stored in the ticketing network guest database 150B, and in step 440, the ticketing network reward software 150E is executed to determine any applicable rewards in step 450.

If the ticketing network server 150 does not receive any indication of an achieved reward, the method returns to step 420 in which additional information is received from the user device database 120B. If a reward is indicated by ticketing network reward database 150C in step 460, however, a notification regarding the reward is sent to the user device 120 in step 470.

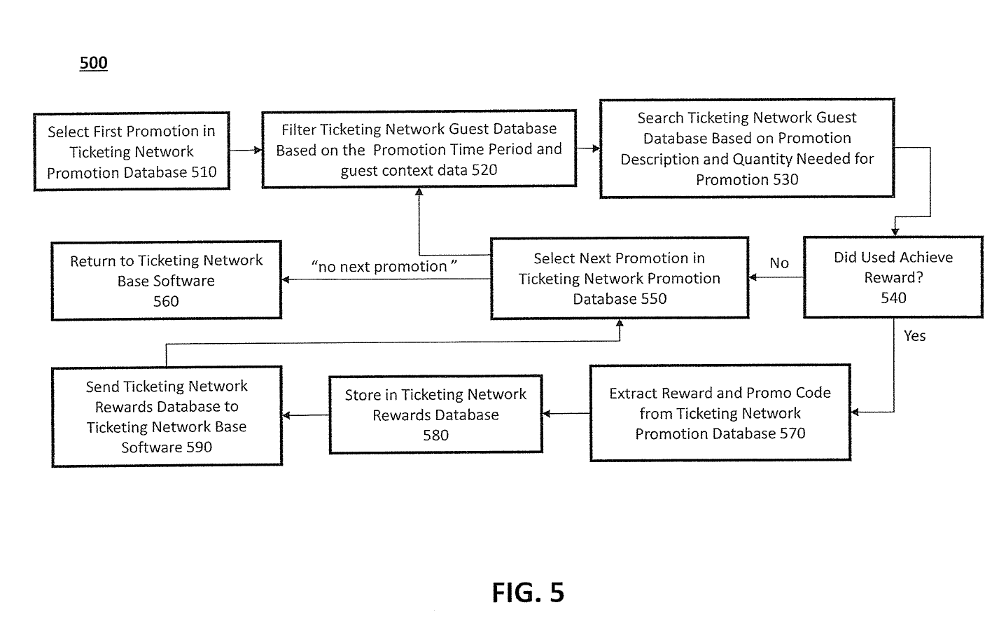

FIG. 5 is a flowchart illustrating an exemplary method 500 performed by a digital ticketing network server 150 that identifies rewards in response to the guest communication device. Such a method 500 involves comparing the data from user device 120 to the ticketing network promotions database 150D in order to determine if the user qualifies for any rewards.

In step 510, a first available promotion from the ticketing network promotion database 150D is evaluated. Such evaluation may be based on information filtered in step 520 from the ticketing network guest database 150B based on various parameters of the promotion (e.g., promotion time period, guest data, and context data). In step 530, the ticket network guest database 150B may be searched based on the promotion description and the quantity needed in order to achieve the promotion (e.g., ride the same attraction five times between 10:00 am and 2:00 pm; if a person is sad or weather, then rewards may be higher). In step 540, it is determined whether the user has achieved a reward. If the user has not achieved the reward, then the method proceeds to step 550 in which another available promotion is evaluated. The method may further revert back to step 520, in which information is filtered for the promotion under evaluation. If there are no more available promotions, the method proceeds to step 560 in which the ticketing network server awaits new communications from user device 120.

If the user did achieve the reward, the method proceeds to step 570 in which reward and associated promo code are extracted from the ticketing network promotion database 150D, which may then be stored in the ticketing network rewards database 150C in step 580. The reward information may be provided to the ticketing network base software 150A for communication to the user device 120 in step 590. The method may then return to step 550 to identify any further promotions that may be available to the guest of user device 120.

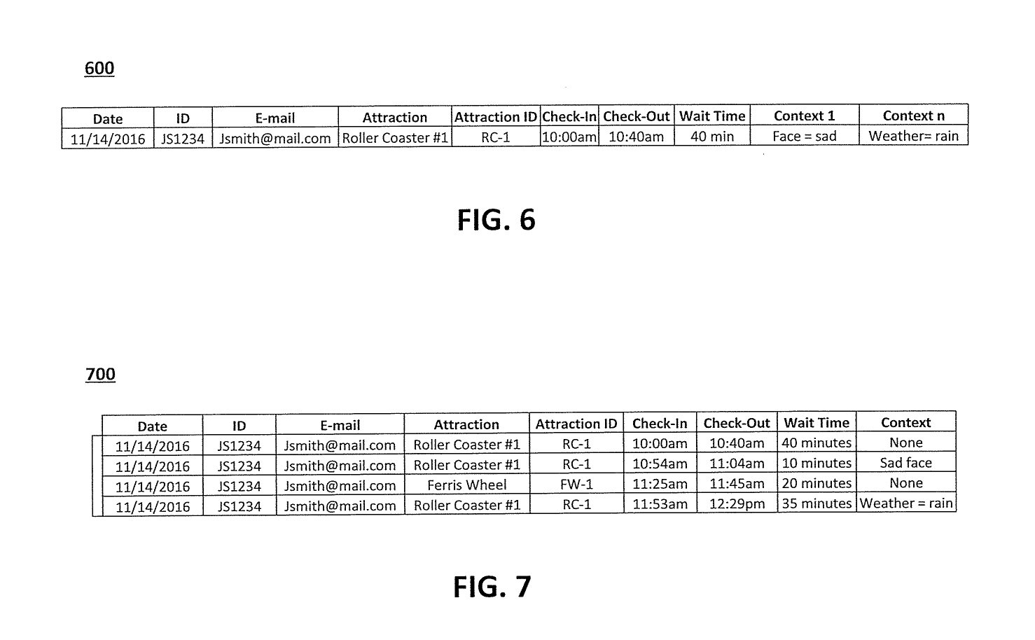

FIG. 6 illustrates an exemplary entry 600 from a user device database 120B that may be used in a system for tracking real-world activities. The entry 600 in user device database 120B may be based on user inputs into the user device GUI 120C, as well as data received from the attraction check-in device 140 and from attraction check-out device 150. The entry 600 in user device database 120B may contain the date, user ID, user e-mail address (or phone number), attraction name, the attraction ID (e.g., attraction ID 130B or attraction ID 140B), the check-in and check-out times (e.g., from clock 130C or 140C, respectively), and the wait time and the various contexts 1-n, which may be identified based on evaluation of the other data (e.g., check-in and check-out times, images, recordings, weather reports). The entry 600 from user device database 120B may be sent to the ticketing network server 150, where it may be considered in combination with previously reported data as maintained in the ticketing network guest database 150B.

FIG. 7 illustrates an exemplary set of entries 700 from a ticketing network guest database 150B that may be used in a system for tracking real-world activities. The entry 700 from ticketing network guest database 150B may be based on received data from the user device 120, as well as previously reported data from the user device 120. The ticketing network guest database 150B may be referenced during evaluation by the ticketing network reward software 150E as to whether the user qualifies for any rewards listed in the ticketing network promotions database 150D. The ticketing network guest database 150B may contain the date, user ID, user e-mail address, attraction name, attraction ID (e.g., attraction ID 130B or attraction ID 140B), the check-in and check-out times (e.g., from clock 130C or 140C, respectively), as well as the wait time as calculated using the check-in and check-out times and other contexts.

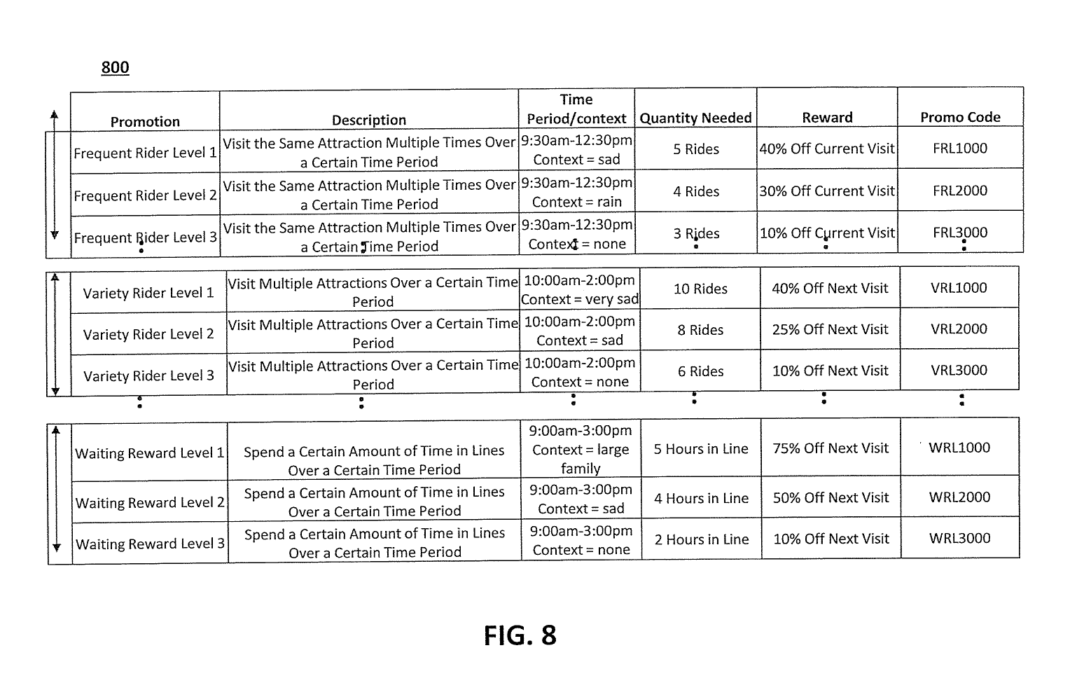

FIG. 8 illustrates an exemplary set of entries 800 from ticketing network promotions database 150D that may be used in a system for tracking real-world activities. Ticketing promotions database 150D may be referenced by the ticketing network rewards software 150E to determine if the user qualifies for any rewards (e.g., by comparing the user data to the parameters of the respective promotion). The entries 800 from ticketing network promotions database 150D may include the promotion (which has various levels), a description of the promotion, time period, quantity needed, the reward, and the promo code.

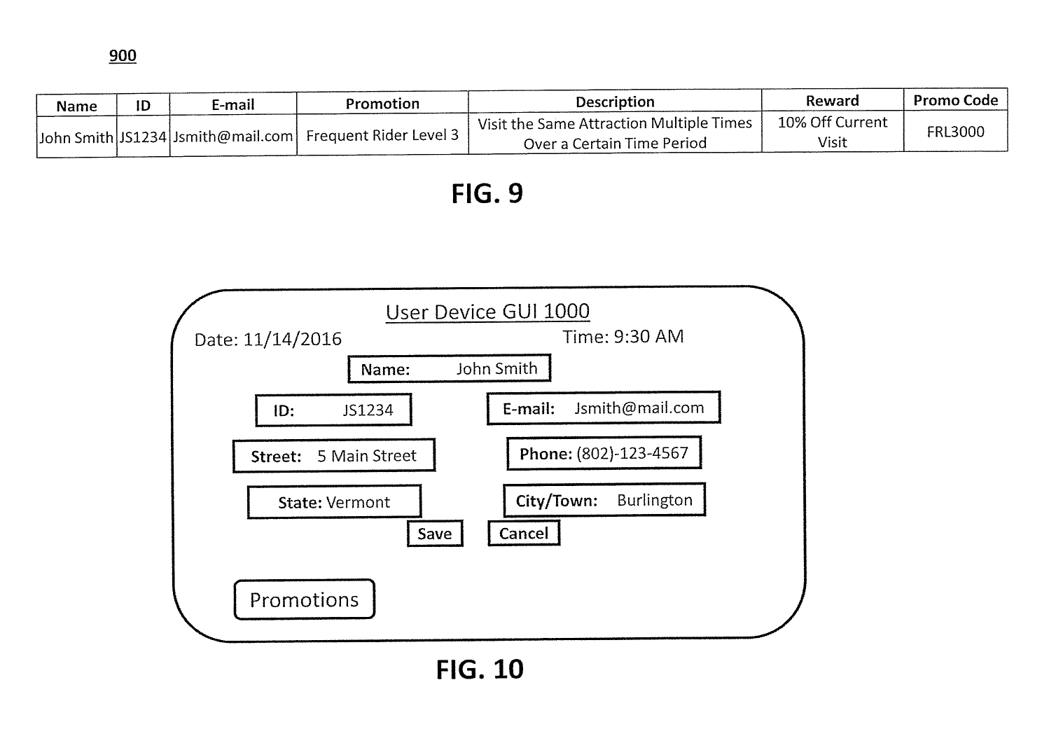

FIG. 9 illustrates an exemplary entry 900 from a ticketing network rewards database that may be used in a system for tracking real-world activities. The entry 900 from ticketing network rewards database 150C may be based on data provided from execution of the ticketing network reward software 150E as to whether the user qualifies for a reward. Such data may be used to update the ticketing network rewards database 150C and sent to the user device 150 to notify the user as to the reward. The entry 900 from ticketing network rewards database 150C may contain the user name, user ID, user e-mail, promotion name, description, reward, and promo code.

FIG. 10 illustrates an exemplary screenshot of a graphic user interface (GUI) 1000 used for input at a user device 120 that may be used in a system for tracking real-world activities. The user device GUI 1000—which may correspond to user device GUI 120C—may be used by the user to input their information (e.g., as part of registration, signing up to receive available promotions). The user device GUI 1000 may contain various fields for the date and time, as well as fields into which the user may input (e.g., user name, user ID, user e-mail, user street address, user phone number, user city/state of residence. The user may then selects the “save” button in order to confirm the inputs, which may then be stored in the user device database 120B. The promotions button may be selected to result in display of available promotions.

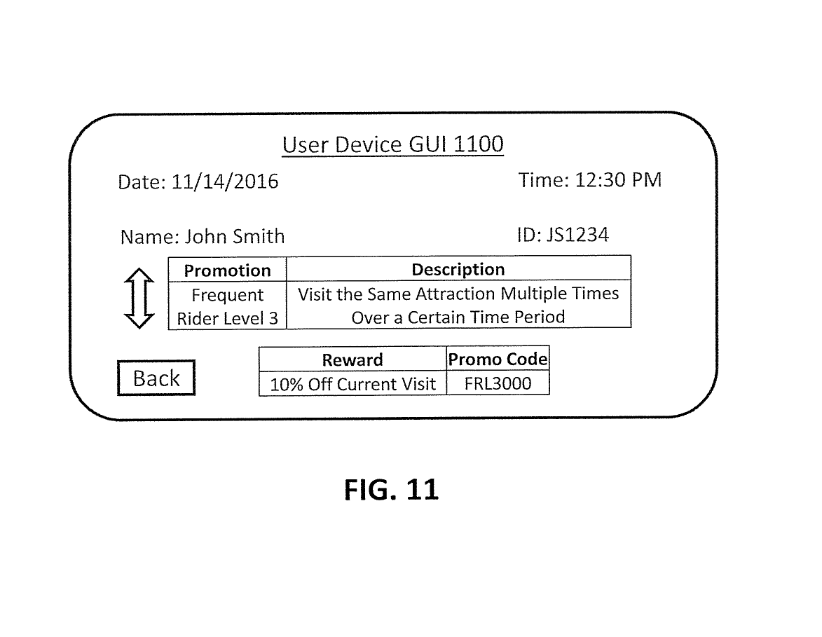

FIG. 11 illustrates an exemplary screenshot of a graphic user interface (GUI) 1100 used for rewards transactions at a user device 120 that may be used in a system for tracking real-world activities. The user device GUI 1100—which may correspond to user device GUI 120C—may display information regarding user-achieved rewards based on a received notification from the ticketing network server 150. The user device GUI 1100 may display the date and time, user name and ID, promotion name and description, and the reward and a promo code for the reward. Different promotions may be displayed in user device BUI 1100 upon scrolling.

FIG. 12 illustrates an exemplary computing system 1200 that may be used to implement an embodiment of the present disclosure. The computing system 1200 of FIG. 12 includes one or more processors 1210 and memory 1220. Main memory 1220 stores, in part, instructions and data for execution by processor 1210. Main memory 1220 can store the executable code when in operation. The system 1200 of FIG. 12 further includes a mass storage device 1230, portable storage medium drive(s) 1240, output devices 1250, user input devices 1260, a graphics display 1270, and peripheral devices 1280.

The components shown in FIG. 12 are depicted as being connected via a single bus 1290. However, the components may be connected through one or more data transport means. For example, processor unit 1210 and main memory 1220 may be connected via a local microprocessor bus, and the mass storage device 1230, peripheral device(s) 1280, portable storage device 1240, and display system 1270 may be connected via one or more input/output (I/O) buses.

Mass storage device 1230, which may be implemented with a magnetic disk drive or an optical disk drive, is a non-volatile storage device for storing data and instructions for use by processor unit 1210. Mass storage device 1230 can store the system software for implementing embodiments of the present disclosure for purposes of loading that software into main memory 1220.

Portable storage device 1240 operates in conjunction with a portable non-volatile storage medium, such as a floppy disk, compact disk or Digital video disc, to input and output data and code to and from the computer system 1200 of FIG. 12. The system software for implementing embodiments of the present disclosure may be stored on such a portable medium and input to the computer system 1200 via the portable storage device 1240.

Input devices 1260 provide a portion of a user interface. Input devices 1260 may include an alpha-numeric keypad, such as a keyboard, for inputting alpha-numeric and other information, or a pointing device, such as a mouse, a trackball, stylus, or cursor direction keys. Additionally, the system 1200 as shown in FIG. 12 includes output devices 1250. Examples of suitable output devices include speakers, printers, network interfaces, and monitors.

Display system 1270 may include a liquid crystal display (LCD) or other suitable display device. Display system 1270 receives textual and graphical information, and processes the information for output to the display device.

Peripherals 1280 may include any type of computer support device to add additional functionality to the computer system. For example, peripheral device(s) 1280 may include a modem or a router.

The components contained in the computer system 1200 of FIG. 12 are those typically found in computer systems that may be suitable for use with embodiments of the present disclosure and are intended to represent a broad category of such computer components that are well known in the art. Thus, the computer system 1200 of FIG. 12 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A system for tracking real-world activities, the system comprising:
a memory configured to store a database which includes:
a digital ticket for each of a plurality of guests of a venue, wherein each of the plurality of guests is associated with a communication device, and
information regarding a plurality of real-world activities, each real-world activity defined based on one or more conditions and associated with a predetermined reward; and
a server comprising:
a communication interface configured to receive information captured by an active communication device associated with of one of the plurality of guests; and
a processor configured to:
execute instructions stored in memory, wherein execution of the instructions by the processor analyzes the captured information to detect one or more conditions associated with one of the plurality of real-world activities, and
update the digital ticket associated with the active communication device regarding the associated predetermined reward;
wherein the communication interface transmits a notification to the active communication device regarding the predetermined reward.

2. The system for tracking real-world activities of claim 1, wherein
the processor is configured to determine that the information captured by the active communication device matches a first one of the conditions, and
the communication interface transmits the notification to the active communication device regarding the predetermined reward, when the information captured by the active communication device matches the one of the conditions.

3. The system for tracking real-world activities of claim 2, wherein
the database includes a promotion database that stores information regarding the one or more conditions; and
the processor is configured to determine that the information captured by the active communication device matches another condition of the one of more conditions, when the information captured by the active communication device does not match the first one of the conditions.

4. The system for tracking real-world activities of claim 3, wherein the promotion database defines a plurality of predetermined rewards and the associated real-world activities necessary to be completed to be eligible for each of the plurality of predetermined rewards.

5. The system for tracking real-world activities of claim 1, wherein the one or more conditions include a plurality of distinct sets of conditions.

6. The system for tracking real-world activities of claim 1, wherein each of the plurality of guests is associated with a distinct communication device.

7. A method for tracking real-world activities, the method comprising:
storing a digital ticket in memory for each of a plurality of guests of a venue, wherein each of the plurality of guests is associated with a communication device;
receiving information regarding a plurality of real-world activities, each real-world activity defined based on one or more conditions and associated with a predetermined reward;
receiving information captured by an active communication device of a given one of the plurality of guests;
detecting one or more conditions associated with one of the real-world activities;
comparing the received information associated with the real-world activities with one or more conditions; and
transmitting a notification to the active communication device regarding to the predetermined rewards.

8. The method for tracking real-world activities of claim 7, wherein
when the information captured by the active communication device of the given one of the plurality of quests matches a first condition, the digital ticket associated with the given one of the plurality of guests is updated to indicate the first condition has been satisfied, and
if the satisfaction of the first condition corresponds with a predetermined reward, the given one of the plurality of guests is notified of the availability of the predetermined reward.

9. The method for tracking real-world activities of claim 8, wherein
when the information captured by the active communication device of the given one of the plurality of guests does not match the first condition, it is determined if the information captured by the active communication of the given one of the plurality of guests matches a second condition,
if the information captured matches the second condition, the digital ticket associated with the given one of the plurality of guests is updated to indicate the second condition has been satisfied, and
if the satisfaction of the second condition corresponds with a second predetermined reward, the given one of the plurality of guests is notified of the availability of the second predetermined reward.

10. The method for tracking real-world activities of claim 7, further comprising storing a promotion database which defines a plurality of predetermined rewards and the associated real-world activities necessary to be completed to be eligible for each of the plurality of predetermined rewards.

11. The method for tracking real-world activities of claim 7, wherein the one or more conditions include a plurality of distinct sets of conditions.

12. The method for tracking real-world activities of claim 7, wherein each of the plurality of guests is associated with a distinct communication device.
